(19) United States
(12) Patent Application Publication
(10) Pub. No.: US 2010/0037221 A1
(43) Pub. Date: Feb. 11, 2010

(54) METHOD AND SYSTEM FOR BUILDING VIRTUAL ENVIRONMENT

(76) Inventor: Wei-Ling Hsieh, Beijing (CN)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 12/267,766

(22) Filed: Nov. 10, 2008

(30) Foreign Application Priority Data
Aug. 11, 2008 (CN) 200810133362.2

(51) Int. Cl. G06F 9/455

(52) U.S. Cl. 718/1

(57) ABSTRACT

The present invention relates to a method and a system for building a virtual environment. The method for building a virtual environment includes: a virtual environment sever obtaining the number of virtual environments to be built; and building the virtual environments with the corresponding number according to the number. Through obtaining the number of the virtual environments to be built and building the virtual environments with the corresponding number by calling directly operating system resources, the system resources occupied by a plurality of heavyweight virtual machines are reduced and the execution efficiency of application programs and the whole efficiency of the operating system are improved.

### CROSS-REFERENCE TO RELATED APPLICATIONS

This application claims the priority benefit of China Patent Application No. 200810133362.2, filed on Aug. 11, 2008, entitled “Method and System for Building Virtual Environment”. The contents of the above identified applications are incorporated herein by reference in its entirety.

### FIELD OF THE TECHNOLOGY

The present invention relates to the computer technology field, and particularly to a method and system for building virtual environment.

### BACKGROUND OF THE INVENTION

A virtual operating system (VOS) is a program for simulating an operating system (OS). The VOS is independent of the OS and can simulate the operating environment which the user is familiar with. The user can store different system configurations, documents and application programs in different VOSs and can switch between different VOSs through clicking the mouse.

The method implementing the switch between the multiple VOSs in prior art is mainly: installing different operating systems time after time with an architecture of a heavy-weight virtual machine and implementing the management and switch between the multiple VOSs installed thereof through the heavy-weight virtual machine.

In the process of implementing the present invention, the inventor finds out that at least following problems exist in the prior art.

1. One operating system is correspondingly installed in every heavy-weight virtual machine. The installing of the multiple heavy-weight virtual machines and the operating systems make the operating system load too many application programs, which may result in that performance efficiency of the application programs falls under serious influence in the architecture of the heavy-weight virtual machine.

2. In the process of switching the virtual environments, the requirement of starting the application program has to pass the virtual operating system and the heavy-weight virtual machine to implement calling of OS system resources, which reduces whole system efficiency of the OS.

### SUMMARY OF THE INVENTION

The present invention provides a method and system for building virtual environment so as to solve the problems that system resources occupied by the heavyweight virtual machine are large and the calling of the system resources of the operating system (OS) calling is implemented only by passing the virtual operating system and the heavyweight virtual machine. In the process of building the virtual environment, the system resources of the OS is directly called so as to reduce the system resources occupied by a plurality of heavyweight virtual machines and improve the execution efficiency of application programs and the whole efficiency of the operating system.

The present invention provides a method for building virtual environment, including the following steps:

A virtual environment sever obtains the number of virtual environments to be built; and

The virtual environments with the corresponding number are built according to the number.

The present invention provides a system for building virtual environment, including a plurality of virtual environments, a virtual environment sever and an operating system.

The virtual environment sever is adapted to obtain the number of the virtual environments to be built and build the virtual environments with corresponding number according to the number;

A plurality of the virtual environments connect respectively with the virtual environment sever; and

The virtual environment includes a user interface, a virtual environment database, at least one application program and a virtual operating system; the user interface and the virtual environment database connect respectively with the virtual environment sever; and the application program connects with the virtual operating system.

In view of the above, through obtaining the number of the virtual environments to be built and building the virtual environments with the corresponding number by calling the directly operating system resources, the embodiments of the present invention reduces the system resources occupied by a plurality of heavyweight virtual machines and improves the execution efficiency of the application programs and the whole efficiency of the operating system.

The present invention will be described in more detail with reference to the drawings and embodiments.

### BRIEF DESCRIPTION OF THE DRAWINGS

FIG. 1 is the flow chart of a method for building a virtual environment according to a first embodiment of the present invention;

FIG. 2 is the flow chart of a method for building a virtual environment according to a second embodiment of the present invention;

FIG. 3 is the flow chart of a method for building a virtual environment according to a third embodiment of the present invention; and

FIG. 4 is the structure view of a system for building a virtual environment according to an embodiment of the present invention.

### DETAILED DESCRIPTION OF THE PREFERRED EMBODIMENTS

Through obtaining the number of the virtual environments to be built and building the virtual environments with the corresponding number by calling directly the operating system resources, the embodiments of the present invention reduces the system resources occupied by a plurality of heavyweight virtual machines and improves the execution efficiency of the application programs and the whole efficiency of the operating system.

A method for building a virtual environment of embodiments of the present invention includes the following steps:

A virtual environment sever obtains the number of virtual environments to be built; and

The virtual environments with the corresponding number are built according to the number.

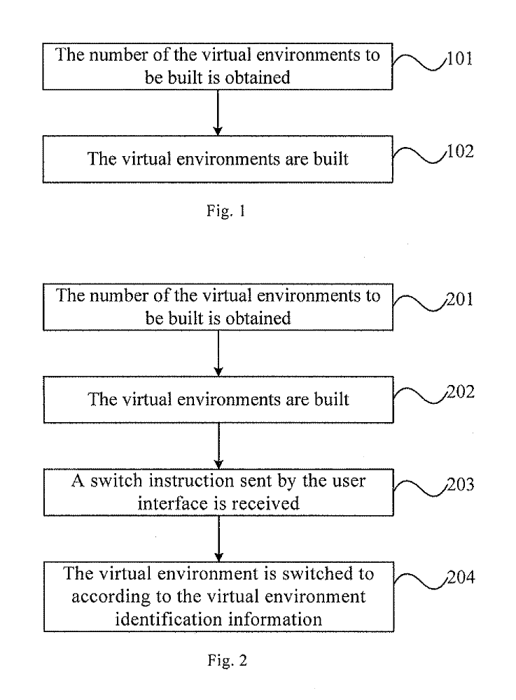

FIG. 1 is the flow chart of a method for building a virtual environment according to a first embodiment of the present invention. As shown in FIG. 1, the embodiment can include the following steps.

Step 101: The number of the virtual environments to be built is obtained.

Information read in this step can be virtual environment attribute information or also be default environment attribute information of the operating system. The virtual environment attribute information can include, but not limited to, one or a few of the following information: configuration information, identification information, information of the application programs and log information of the virtual environment. The default environment attribute information can include, but not limited to, one or a few of the following information: default configuration information, the identification information, the information of the application programs and the log information. The virtual environment sever can be stored in a hard disk, a movable storage device and other kinds of storage medium, such as a network side sever. Different virtual environments can store different types of files, for example, the virtual environment can store a plurality of office software for working; and the virtual environment can store a plurality of game software for amusing.

A desktop is to build its own default environment attribute information after starting the operating system. After running the virtual environment sever in the operating system, the virtual environment sever reads the virtual environment attribute information stored in the virtual environment database of the movable storage device and obtains the number of the virtual environments, that is, records the number of the virtual environment attribute information read and stores the virtual environment identification information which is in the virtual environment attribute information.

Furthermore, the virtual environment sever also reads the default environment attribute information of the operating system its own and stores the default environment attribute information.

Step 102: The virtual environments are built.

The related information required in building the virtual environments can be stored in the hard disk, or also can be stored in the movable storage device. The related information required in building the virtual environments can include, but not limited to, one or a few of the following information: the configuration information, the identification information, the information of the application programs and the log information of the virtual environment. A user interface adopts a selecting manner to provide the user with selecting operations. The user interface can be implemented by adopting one of types, such as selecting manner, selecting pull-down menus and so on.

The virtual environment sever builds the virtual environments with the corresponding number according to the number of the virtual environments obtained. The virtual environment sever calls the related information from the movable storage device to configure the virtual environment according to the virtual environment attribute information. The virtual environment corresponds to the virtual environment attribute information one by one.

Furthermore, the virtual environment sever builds respectively different user interfaces for all the virtual environments while the virtual environment sever builds the virtual environments. Each of the user interfaces matches the different virtual environment attribute information. The virtual environment sever also builds one user interface to the operating system. This user interface matches the default environment attribute information.

In the present embodiment, the number of the virtual environments to be built is obtained and the virtual environments with the corresponding number are built by calling directly operating system resources. The embodiment of the present invention reduces the system resources occupied by a plurality of heavyweight virtual machines and improves the execution efficiency of the application programs and the whole efficiency of the operating system.

Furthermore, the virtual environment attribute information is stored in the virtual environment database. The virtual environment database also stores the related information required in building the virtual environment. The virtual environment database corresponds to the virtual environment one by one.

FIG. 2 is the flow chart of a method for building a virtual environment according to a second embodiment of the present invention. As shown in FIG. 2, the embodiment can include the following steps.

Step 201: The number of the virtual environments to be built is obtained.

The information read in this step can be the virtual environment attribute information or the default environment attribute information of the operating system. The virtual environment attribute information can include, but not limited to, one or a few of the following information: the configuration information, the identification information, the information of the application programs and the log information of the virtual environment. The default environment attribute information can include, but not limited to, one or a few of the following information: the default configuration information, the identification information, the information of the application programs and the log information. The virtual environment sever can be stored in the hard disk, the movable storage device, the network side sever or other kinds of storage medium. Different virtual environments can store different types of files, for example, the virtual environment can store a plurality of office software for working; and the virtual environment can store a plurality of game software for amusing.

A desktop is to build its own default environment attribute information after starting the operating system. After running the virtual environment sever in the operating system, the virtual environment sever reads the virtual environment attribute information stored in the virtual environment database of the movable storage device and obtains the number of the virtual environments, that is, records the number of the virtual environment attribute information read, and stores the virtual environment identification information which is in the virtual environment attribute information.

Furthermore, the virtual environment sever also reads the default environment attribute information of the operating system its own and stores the default environment attribute information.

Step 202: The virtual environments are built.

The related information required in building the virtual environments can be stored in the hard disk, or also can be stored in the movable storage device. The related information required in building the virtual environments can include, but not limited to, one or a few of the following information: the configuration information, the identification information, the information of the application programs of the virtual environment, the log information and so on. The user interface adopts the selecting manner to provide the user with the selecting operations. The user interface can be implemented by adopting one of the types, such as the selecting manner, the selecting pull-down menus and so on.

The virtual environment sever builds the virtual environments with the corresponding number according to the number of the virtual environments obtained. The virtual environment sever calls the related information from the movable storage device to configure the virtual environment according to the virtual environment attribute information. The virtual environment corresponds to the virtual environment attribute information one by one.

Furthermore, the virtual environment sever builds respectively different user interfaces for all the virtual environments while the virtual environment sever builds the virtual environments. Each of the user interfaces matches the different virtual environment attribute information. The virtual environment sever also builds one user interface to the operating system. This user interface matches the default environment attribute information.

For example, after reading the virtual environment attribute information, the virtual environment sever records the number of the virtual environment attribute information read. If the number of the virtual environment attribute information is 2, the virtual environment sever calls one item or a combination of more items of the corresponding information, i.e., the system configuration information, the identification information, the information of the application programs, the log information and so on, and builds two virtual environments. At the same time, the user interface is built and the user interface includes two key-presses. If the two virtual environment attribute information are respectively “work” and “game”, the names of the two key-presses are respectively “work” and “game”. The names of the key-presses correspond respectively to the two virtual environment attribute information. Furthermore, the two virtual environments run in the background of the operating system after the virtual environments are built. The user also can limit the type of the software which is compatible with the virtual environment. For example, in the virtual environment as “work”, only the office software can be compatible; in the virtual environment as “game”, only the “racing bicycle game” software can be compatible, and other types of the software can not be compatible with this virtual environment.

Step 203: A switch instruction sent by the user interface is received.

The user interface adopts the selecting manner to provide the user with the selecting operations. There is the user interface of the default environment corresponding to the default environment. The selecting manner also exists in the default environment of the operating system. The switch instruction can be sent to the virtual environment sever from the different user interfaces which are selected by the user using external connecting input device, such as a keyboard or a mouse. The user interface adopts the selecting manner to provide the user with the selecting operations. The user interface can be implemented by adopting one of the types, such as the selecting manner, the selecting pull-down menus and so on.

The virtual environment sever builds one user interface in the default environment after building a plurality of the virtual environments. The user interface includes the selecting manners corresponding to a plurality of the virtual environments. Each of the selecting manner of the user interfaces corresponds uniquely to one virtual environment identification information.

In spite of being in the default environment or in the virtual environment, when the user spots the selecting manner of the user interface of the virtual environment, the user interface sends one switch instruction to the virtual environment sever. The switch instruction carries the virtual environment identification information. The virtual environment identification information corresponds to the virtual environment selected by the user one by one.

Furthermore, the virtual environment identification information is carried by the virtual environment attribute information, which is stored in the virtual environment database.

For example, after the virtual environment sever builds the two virtual environments which are “work” and “game”, the two virtual environments run in the background of the operating system. Here, the user interface can be displayed on the desktop. The user interface includes two key-presses named as “work” and “game” respectively. When the user clicks the key-press “work” by using the input device, such as the keyboard or the mouse, the user interface sends one switch instruction to the virtual environment sever. The switch instruction carries the virtual environment identification information “work”. This identification information “work” has been copied to the virtual environment sever when the virtual environment sever reads the virtual environment identification information, and the identification information “work” corresponds to the virtual environment one by one.

Step 204: The virtual environment is switched to according to the virtual environment identification information.

The virtual environment identification information can be the name of the virtual environment and the name can be defined by the user according to the requirement.

After the virtual environment sever receives the switch instruction sent by the user interface, the virtual environment identification information is obtained from the switch instruction and the corresponding virtual environment which is already built is switched to according to the matching relation between the virtual environment identification information and the virtual environment.

For example, after the virtual environment sever receives the switch instruction sent by the user interface, if the virtual environment identification information obtained from the switch instruction is “work”, the virtual environment sever switches the desktop to the virtual environment named as “work” which runs in the background of the operating system according to the matching relation between the virtual environment identification information “work” stored in itself and the virtual environment. The two user interfaces named as “work” and “game” can still be displayed in the virtual environment. As the same method, if the user click the user interface named as “game” in the environment as “work”, the user interface sends the switch instruction to the virtual environment sever and the virtual environment sever switches the desktop to the virtual environment as “game” according to the virtual environment identification information “game” carried by the switching instruction.

In the present embodiment, the number of the virtual environments to be built is obtained and the virtual environments with the corresponding number are built by calling directly operating system resources. The embodiment of the present invention reduces the system resources occupied by a plurality of heavyweight virtual machines and improves the execution efficiency of the application programs and the whole efficiency of the operating system.

Furthermore, the virtual environment attribute information is stored in the virtual environment database. The virtual environment database also stores the related information required in building the virtual environment.

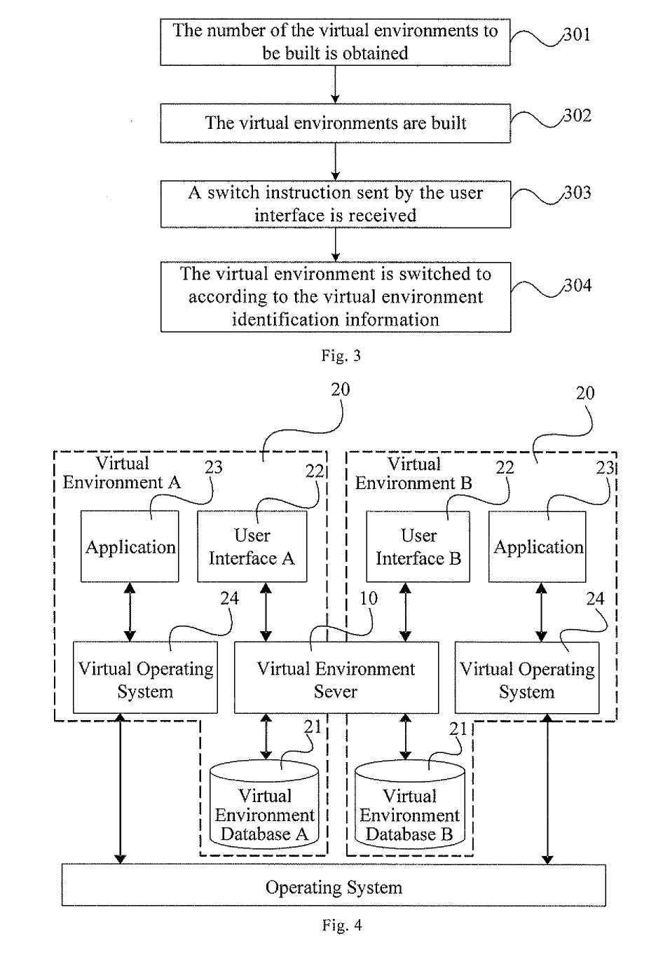

FIG. 3 is the flow chart of a method for building a virtual environment according to a third embodiment of the present invention. As shown in FIG. 3, the embodiment can include the following steps.

Step 301: The number of the virtual environments to be built is obtained.

The information read in this step can be the virtual environment attribute information or the default environment attribute information of the operating system. The virtual environment attribute information can include, but not limited to, one or a few of the following information: the configuration information, the identification information, the information of the application programs and the log information of the virtual environment. The default environment attribute information can include, but not limited to, one or a few of the following information: the default configuration information, the identification information, the information of the application programs and the log information. The virtual environment sever can be stored in the hard disk, the movable storage device, the network side sever or other kinds of storage medium. Different virtual environments can store different types of files, for example, the virtual environment can store a plurality of office software for working; and the virtual environment can store a plurality of game software for amusing.

A desktop is to build its own default environment attribute information after starting the operating system. After running the virtual environment sever in the operating system, the virtual environment sever reads the virtual environment attribute information stored in the virtual environment database of the movable storage device and obtains the number of the virtual environments, that is, records the number of the virtual environment attribute information read, and stores the virtual environment identification information which is in the virtual environment attribute information.

Furthermore, the virtual environment sever also reads the default environment attribute information of the operating system its own and stores the default environment attribute information.

Step 302: The virtual environments are built.

The related information required by building the virtual environments can be stored in the hard disk, or also can be stored in the movable storage device. The related information required by building the virtual environments can include, but not limited to, one or a few of the following information which are the configuration information, the identification information, the information of the application programs and the log information of the virtual environment. A user interface can adopt a select manner to provide the user with the selecting operations. The user interface can be implemented by adopting the type of selecting manner, selecting pull-down menus and so on.

The virtual environment sever builds the virtual environments with the corresponding number according to the number of the virtual environments obtained. The virtual environment sever calls the corresponding information from the movable storage device to configure the virtual environment according to the virtual environment attribute information. The virtual environment corresponds to the virtual environment attribute information one by one.

Furthermore, the virtual environment sever builds different user interfaces for all the virtual environments respectively while the virtual environment sever builds the virtual environments. Each of the user interfaces matches with the different virtual environment attribute information. The virtual environment sever also builds one user interface to the operating system. This user interface matches with the default environment attribute information.

For example, after reading the default environment attribute information and the virtual environment attribute information, the virtual environment sever calls one item or one combination of more items of the corresponding information, such as the system configuration information, the identification information, the information of the application programs, the log information and so on, and builds one virtual environment. At the same time, the user interface is built and the user interface includes two key-presses. If the default environment identification information is “default” and the virtual environment identification information is “work”, the names of the two key-presses are respectively “default” and “work”. The names of the key-presses correspond respectively to the two virtual environment attribute information. Furthermore, the virtual environment runs in the background of the operating system after building the virtual environment named as “work”. The operating system that the user can see is the default environment, that is, the desktop of the operating system.

Step 303: A switch instruction sent by the user interface is received.

The user interface adopts the selecting manner to provide the user with the selecting operations. There is the user interface of the default environment corresponding to the default environment. The selecting manner also exists in the default environment of the operating system. The switch instruction can be sent to the virtual environment sever from the different user interfaces which are selected by the user using external connecting input device, such as a keyboard or a mouse. The user interface adopts the selecting manner to provide the user with the selecting operations. The user interface can be implemented by adopting one of the types, such as the selecting manner, the selecting pull-down menus and so on.

The virtual environment sever builds one user interface in the default environment after building a plurality of the virtual environments. The user interface includes the selecting manners corresponding to a plurality of the virtual environments. Each of the selecting manners of the user interfaces corresponds uniquely to one virtual environment identification information.

In spite of being in the default environment or in the virtual environment, when the user spots the selecting manner of the user interface of the virtual environment, the user interface sends one switch instruction to the virtual environment sever. The switch instruction carries the virtual environment identification information. The virtual environment identification information corresponds to the virtual environment selected by the user one by one.

Furthermore, the virtual environment identification information is carried by the virtual environment attribute information, which is stored in the virtual environment database.

For example, after the virtual environment sever builds the virtual environment and the user interface, the virtual environment runs in the background of the operating system. The operating environment that the user can see is the default environment, that is, the desktop of the operating system. Here, the user interface can be displayed on the desktop. The user interface includes two key-presses named as “default” and “work” respectively. When the user clicks the key-press “work” by using the input device, such as the keyboard or the mouse, the user interface sends one switch instruction to the virtual environment sever. The switch instruction carries the virtual environment identification information “work”. This identification information “work” has been copied to the virtual environment sever when the virtual environment sever reads the virtual environment identification information, and the identification information “work” corresponds to the virtual environment one by one.

Step 304: The virtual environment is switched to according to the virtual environment identification information.

The virtual environment identification information can be the name of the virtual environment and the name can be defined by the user according to the requirement;

After the virtual environment sever receives the switch instruction sent by the user interface, the virtual environment identification information is obtained from the switch instruction and the corresponding virtual environment which is already built is switched to according to the matching relation between the virtual environment identification information and the virtual environment.

For example, after the virtual environment sever receives the switch instruction sent by the user interface, if the virtual environment identification information obtained from the switch instruction is “work”, the virtual environment sever switches the desktop to the virtual environment named as “work” which runs in the background of the operating system according to the matching relation between the virtual environment identification information “work” stored in itself and the virtual environment. The two user interfaces named as “default” and “work” can still be displayed in the virtual environment. When performing a reverse operation, the user clicks the user interface named as “default” on the desktop of the virtual environment, the user interface sends the switch instruction to the virtual environment sever. The virtual environment sever switches the desktop to the desktop of the operating system itself according to the default environment identification information carried in the switch instruction.

In the present embodiment, the number of the virtual environments to be built is obtained and the virtual environments with the corresponding number are built by calling directly operating system resources. The embodiment of the present invention reduces the system resources occupied by a plurality of heavyweight virtual machines and improves the execution efficiency of the application programs and the whole efficiency of the operating system.

Furthermore, the virtual environment attribute information is stored in the virtual environment database. The virtual environment database also stores the related information required in building the virtual environment.

FIG. 4 is the structure view of a system for building a virtual environment according to an embodiment of the present invention. As shown in FIG. 4, the system for building the virtual environment in the embodiment may include a virtual environment sever 10 and a plurality of the virtual environments 20. The virtual environment sever 10 connects respectively a plurality of the virtual environments 20. The virtual environment sever 10 is adapted to obtain the number of the virtual environments to be built and build the virtual environments with the corresponding number according to the number. A plurality of the virtual environments 20 connect respectively with the virtual environment sever 10. The virtual environment 20 includes a virtual environment database 21, a user interface 22, at least one application program 23 and a virtual operating system 24; the user interface 22 and the virtual environment database 21 connect respectively with the virtual environment sever 10; the application program 23 connects with the virtual operating system 24; and the operating system connects with the virtual operating system 24.

The user interface 22 is adapted to send a switch instruction to the virtual environment sever 10. The switch instruction carries the virtual environment identification information. The virtual environment database 21 is adapted to store the matching relation between the virtual environment identification information and the virtual environments 20. The virtual environment sever 10 connects respectively with the user interface 22 and the virtual environment database 21 of each of the virtual environments 20, which is adapted to receive the switch instruction sent by the user interface 22 and switch to the corresponding virtual environment 20 according to the virtual environment identification information carried by the switch instruction.

The virtual environment sever 10 in the embodiment connects with the virtual environment database 21 in a plurality of the virtual environments 20. After the operating system is started, the virtual environment sever 10 runs and reads the virtual environment attribute information from all of the virtual environment database 21 connected with the virtual environment sever 10, obtains the number of the virtual environments to be built and builds the virtual environments with the corresponding number. In spite of being in the default environment or in the virtual environment 20, when the user clicks the user interface 22 of the virtual environment 20, the user interface 22 sends a switch instruction to the virtual environment sever 10. The switch instruction carries the virtual environment identification information. The virtual environment sever 10 switches to the corresponding virtual environment 20 according to the matching relation between the virtual environment identification information and the virtual environment 20.

Furthermore, the matching relation between the virtual environment identification information and the virtual environments 20 is stored in the virtual environment database 21. When reading the virtual environment attribute information, the virtual environment server 10 has already copied the matching relation between the virtual environment identification information and the virtual environments 20 to itself for storing.

In the present embodiment, the number of the virtual environments to be built is obtained and the virtual environments with the corresponding number are built by calling directly operating system resources. The embodiment of the present invention reduces the system resources occupied by a plurality of heavyweight virtual machines and improves the execution efficiency of the application programs and the whole efficiency of the operating system.

Furthermore, the virtual environment in the system for building the virtual environment of the embodiment still includes the application program 23 and the virtual operating system 24. The virtual operating system 24 is stored in the user's mode space for loading the application programs when starting each of the application programs. As the virtual operating system 24 includes hanging parts which can execute different functions, when the different application programs 23 are started, the virtual operating system 24 hitches the different hanging parts for the application program 23 to make the application program 23 complete its operation according to the different operations needed to be executed by the application program 23. All of the hanging parts in the virtual operating system 24 are a plurality of dynamic link library files stored in the operating system, so the system resources of the operating system are called directly during process of executing the application program 23 to improve the whole efficiency of the operating system.

The common technicians in the art should be understood that the whole or part of the steps for implementing the above method can be completed by the hardware corresponding to the program instructions. The program can be stored in a storage medium which can be read by the computer. The steps included in the above method embodiments are executed when the program is executed. The foregoing storage medium includes diversified media which can store the program codes, such as ROM, RAM, magnetic disk or Compact Disc.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A method for building a virtual environment, comprising:
obtaining, by a virtual environment sever, the number of virtual environments to be built; and
building the virtual environments with the corresponding number according to the number.

2. The method according to claim 1, wherein the step of obtaining, by the virtual environment sever, the number of the virtual environments to be built comprises: recording, by the virtual environment sever, the number of virtual environment attribute information read.

3. The method according to claim 2, wherein default environment attribute information is read while the virtual environment attribute information is read and a default user interface is built.

4. The method according to claim 3, wherein a user interface corresponding to the virtual environment is built while the virtual environments with the corresponding number are built according to the number.

5. The method according to claim 4, wherein the user interface sends a switch instruction and to command the virtual environment sever to switch the virtual environment.

6. The method according to claim 5, wherein the switch instruction carries virtual environment identification information.

7. The method according to claim 6, wherein the virtual environment identification information matches the virtual environment.

8. The method according to claim 5, wherein the switch instruction further carries default environment identification information.

9. The method according to claim 6, wherein the switch instruction further carries default environment identification information.

10. The method according to claim 8, wherein the step of switching the virtual environment further comprises: switching to a default environment according to the default environment identification information.

11. The method according to claim 8, wherein the default environment identification information matches the default environment.

12. A system for building a virtual environment, comprising: a plurality of virtual environments, a virtual environment sever and an operating system; wherein
the virtual environment sever is adapted to obtain the number of the virtual environments to be built and build the virtual environments with the corresponding number according to the number;
a plurality of the virtual environments connect respectively with the virtual environment sever; and
the virtual environment comprises: a user interface, a virtual environment database, at least one application program and a virtual operating system, the user interface and the virtual environment database connect respectively with the virtual environment sever and the application program connects with the virtual operating system.
